(19) United States
(12) Patent Application Publication
(10) Pub. No.: US 2015/0300086 A1
(43) Pub. Date: Oct. 22, 2015

(54) SPRING-ASSISTED CORDLESS ROLLER SHADE WITHOUT CLUTCH SYSTEM

(71) Applicants: I-MING CHEN, TAIPEI CITY (TW); YAO-TSUNG CHEN, MIAOLI COUNTY (TW)

(72) Inventors: I-MING CHEN, TAIPEI CITY (TW); YAO-TSUNG CHEN, MIAOLI COUNTY (TW)

(21) Appl. No.: 14/305,065

(22) Filed: Jun. 16, 2014

(30) Foreign Application Priority Data
Apr. 17, 2014 (CN) 201420188203.3

(51) Int. Cl. E06B 9/60; E06B 9/78

(52) U.S. Cl. CPC E06B 9/60; E06B 9/78

(57) ABSTRACT

A spring-assisted cordless roller shade without clutch system includes a tubular body defining an internal space. The internal space has a first section and a second section. In each of the first and second sections is mounted a connector, a central shaft assembled with the connector, a fixing member pivotally connected with the central shaft and a transmission shaft disposed on the fixing member. An elastic member is disposed between the connector and the central shaft to provide a frictional force for controlling and adjusting the rotation of the tubular body. A rotational section is mounted on the transmission shaft of the first section and rotatable along with the tubular body. A band-type spring module is assembled with the transmission shaft of the second section. When the operational force applied to the shade disappears, the shade is immediately located.

### BACKGROUND OF THE INVENTION

1. Field of the Invention

The present invention relates generally to a spring-assisted cordless roller shade without clutch system, and more particularly to a shade lifting/lowering device including a tubular body, a connector, a transmission shaft, a fixing member and a band-type spring module for controlling winding/unwinding of the shade and locating the shade.

2. Description of the Related Art

A conventional shade locating/controlling device is applied to a shade or the like and assembled with a rotary shaft. The shade locating/controlling device and the rotary shaft are mounted in a tubular housing. The shade locating/controlling device cooperates with a cord or a bead chain drive seat, a locking device and springs to control the winding/unwinding of the shade.

As well known by those who are skilled in this field, the cord or bead chain system for winding/unwinding the shade is dangerous to children. To overcome this problem, an improved bead chain structure has been developed.

With respect to the structural design of the shade control device, the conventional device also employs brake system and clutch mechanism to control the winding/unwinding operation of the shade and locate the shade. In general, such assembly is relatively complicated and it is troublesome and time-consuming to install the assembly. Moreover, such structure necessitates a torsion spring with large torque for controlling the shade. As a result, a user needs to apply a greater force to the shade for discharging the clutch from locking effect so as to pull the shade. This is not what we expect.

The conventional shade control or roller shade structure and the relevant connection components thereof have some shortcomings in use and structural design that need to be overcome. It is therefore tried by the applicant to provide a shade lifting/lowering device to eliminate the shortcomings existing in the conventional shade control structure so as to widen the application range. For example, in comparison with the conventional shade control structure, the shade lifting/lowering device of the present invention has a simplified structure and is easy to operate. The shade lifting/lowering device of the present invention is free from any bead chain or cord system so that the security in operation of the shade is ensured. In contrast, the conventional shade control structure is troublesome to install and laborious to operate.

### SUMMARY OF THE INVENTION

It is therefore a primary object of the present invention to provide a spring-assisted cordless roller shade without clutch system includes a tubular body defining an internal space. The internal space has a first section and a second section. In each of the first and second sections is mounted a connector, a central shaft assembled with the connector, a fixing member pivotally connected with the central shaft and a transmission shaft disposed on the fixing member. An elastic member is disposed between the connector and the central shaft to provide a frictional force for controlling and adjusting the rotation of the tubular body. A rotational section is mounted on the transmission shaft of the first section and rotatable along with the tubular body. A band-type spring module is assembled with the transmission shaft of the second section. When the operational force applied to the shade disappears, the shade is immediately located. The shade lifting/lowering device of the present invention is free from the clutch system of the conventional device so that the structure of the shade lifting/lowering device is simplified.

In the above spring-assisted cordless roller shade without clutch system, a base seat is assembled with the connector, whereby the connectors are mounted at two ends of the tubular body. The base seat defines a chamber in which the central shaft is mounted. The elastic member is disposed between the chamber of the base seat and the central shaft, permitting the central shaft to axially move within the chamber to provide a frictional force for controlling the rotation of the tubular body or the winding of the shade.

In the above spring-assisted cordless roller shade without clutch system, the band-type spring module includes a housing and a belt spring disposed in the housing. The housing is rotatable along with the tubular body. One end of the belt spring is affixed to the transmission shaft, while the other end of the belt spring is mounted in a perforation of the housing. When the tubular body and the housing are rotated, the belt spring is forced to store energy or release energy.

The present invention can be best understood through the following description and accompanying drawings, wherein:

### BRIEF DESCRIPTION OF THE DRAWINGS

FIG. 1 is a perspective assembled view of the present invention, in which the phantom lines show that the shade or the like is wound on the tubular body;

FIG. 2 is a perspective exploded view of the present invention, showing the tubular body, the connector, the fixing member and the band-type spring module;

FIG. 3 is a perspective exploded view of the present invention, showing the connector, the fixing member, the spring and the rotational section of the first section of the tubular body;

FIG. 4 is a sectional view of the present invention, showing the assembly of the first section of the tubular body;

FIG. 5 is a perspective exploded view of the present invention, showing the connector, the fixing member and the band-type spring module of the second section of the tubular body; and

FIG. 6 is a sectional view of the present invention, showing the assembly of the second section of the tubular body.

### DETAILED DESCRIPTION OF THE PREFERRED EMBODIMENTS

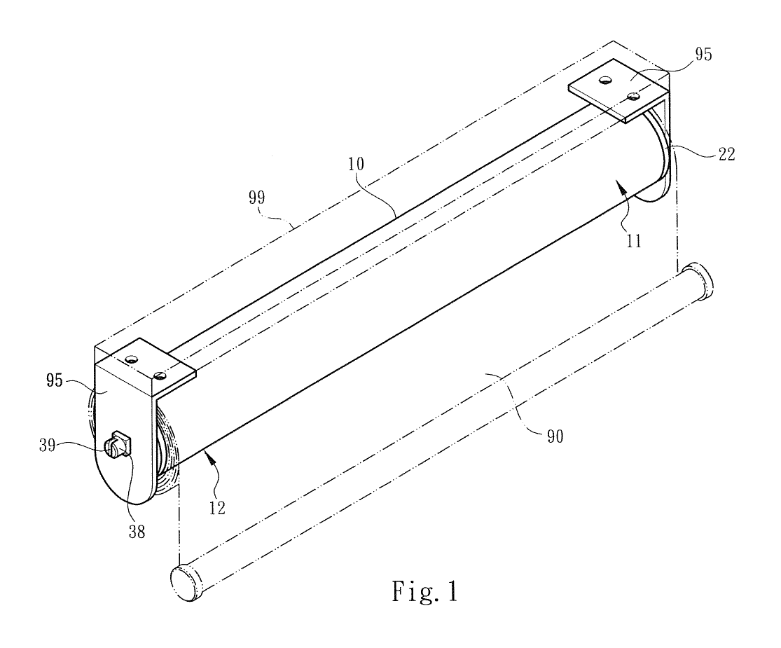

Please refer to FIGS. 1, 2 and 3. The present invention includes a tubular body 10 for winding a shade 90 or the like. When the shade 90 is pulled, the tubular body 10 is driven and rotated. The tubular body 10 defines an internal space 15 having a first section 11 and a second section 12. The tubular body 10 has a drive section 13 extending through the first and second sections 11, 12 in the form of an insertion block. In each of the first and second sections 11, 12 are mounted a connector 20, a central shaft 30 assembled with the connector 20, a fixing member 40 pivotally connected with the central shaft 30 and a transmission shaft 50 disposed on the fixing member 40.

In this embodiment, the connector 20 is a cylindrical body formed with a channel 21 in which the drive section 13 is inlaid, whereby the connector 20 is rotatable along with the tubular body 10. Abase seat 22 is assembled with the connector 20, whereby the connectors 20 are mounted at two ends of the tubular body 10. The base seat 22 is a tubular body defining a chamber 23 and having an extension wall 24. The central shaft 30 is mounted in the chamber 23. The central shaft 30 includes a head section 31 and a shaft section 32 connected with the head section 31. The central shaft 30 has a buffering room 33, whereby when the central shaft 30 is moved, the central shaft 30 will not interfere with the transmission shaft 50.

To speak more specifically, the width (or outer diameter) of the head section 31 is larger than the width (or outer diameter) of the shaft section 32, whereby a shoulder section 34 is formed between the head section 31 and the shaft section 32. The shaft section 32 has a free end 35 extending out of the base seat 22. A subsidiary shoulder section 36 is formed on the surface of the shaft section 32 in a position where the shaft section 32 protrudes out of the base seat 22. An elastic member 37 is disposed between the chamber 23 of the base seat and the shaft section 32 of the central shaft 30, permitting the central shaft 30 to axially move within the chamber 23 to provide a frictional force for controlling the rotation of the tubular body 10. That is, by means of adjusting the position of the central shaft 30 in the chamber 23, the push force applied by the elastic member 37 to the base seat 22 (or the extension wall 24) is adjustable to control the rotation of the tubular body 10.

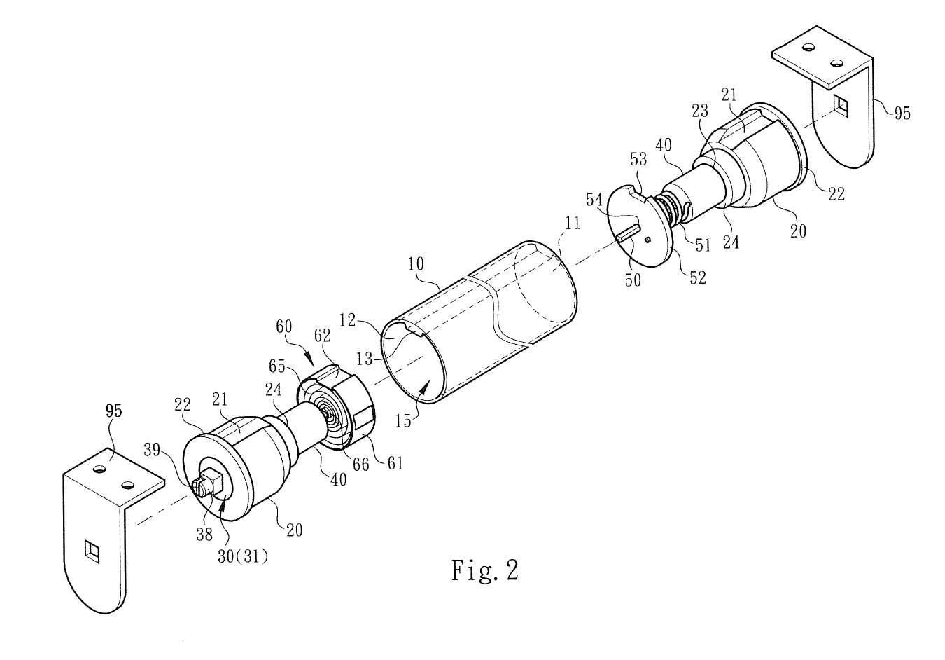

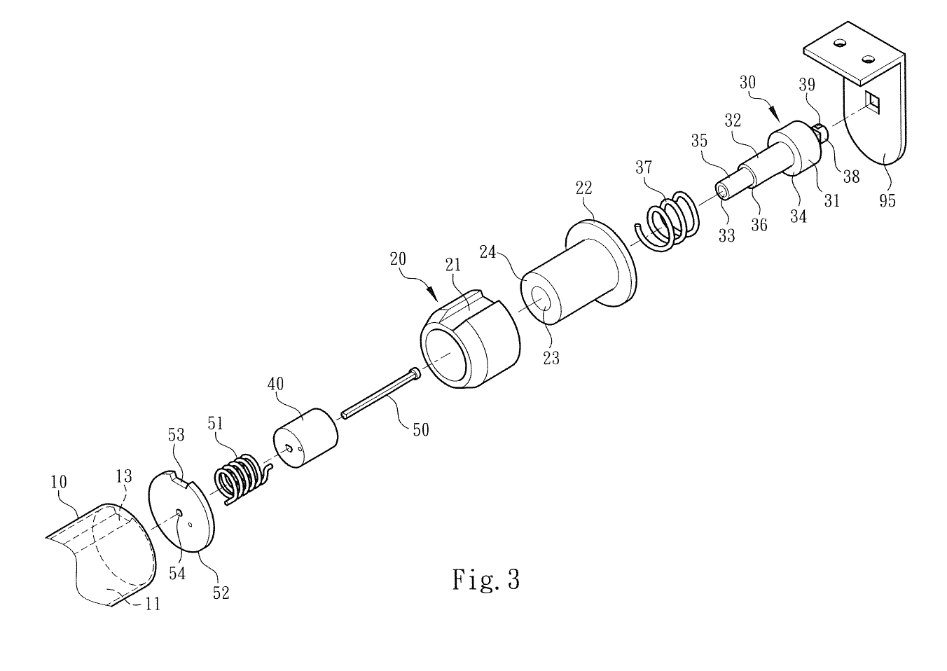

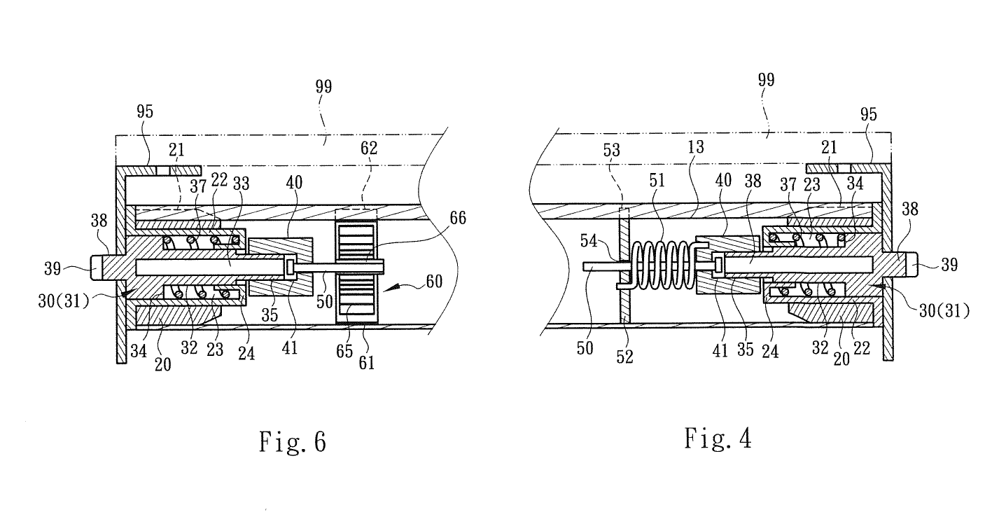

As shown in FIGS. 2 and 3, a boss section 38 is formed on the head section 31 of the central shaft 30. A split 39 is formed on the boss section 38. A fixing plate 95 is assembled with the boss section 38, whereby the tubular body 10 and the base seat 22 can be fixedly mounted on a base face 99 (as shown in FIG. 4 or FIG. 6). The split 39 enables an operator to use a tool to rotate or push the central shaft 30 to axially move.

FIG. 4 shows that the elastic member 37 is a compression spring fitted around the shaft section 32. One end of the elastic member 37 abuts against the shoulder section 34, while the other end of the elastic member 37 abuts against the extension wall 24 of the base seat. The free end 35 of the shaft section 32 is assembled with the fixing member 40. The fixing member 40 is formed with a through hole 41 in which the transmission shaft 50 is pivotally fitted. In this embodiment, the transmission shaft 50 extends out of the fixing member 40. An elastic element 51 is fitted around the transmission shaft 50 and a rotational section 52 is pivotally fitted on the transmission shaft 50.

To speak more specifically, the elastic element 51 is a torsion spring having two ends respectively affixed to the fixing member 40 and the rotational section 52. By means of rotating the rotational section 52 (or the fixing member 40), the elastic force of the elastic element 51 is adjustable. The rotational section 52 has the form of a rotational disc. The rotational section 52 is formed with a shaft hole 54 in which the transmission shaft 50 is pivotally fitted. The rotational section 52 is formed with a notch 53 in which the drive section 13 of the tubular body 10 is inlaid. Accordingly, the rotational section 52 is rotatable along with the tubular body 10 to drive and rotate the fixing member 40.

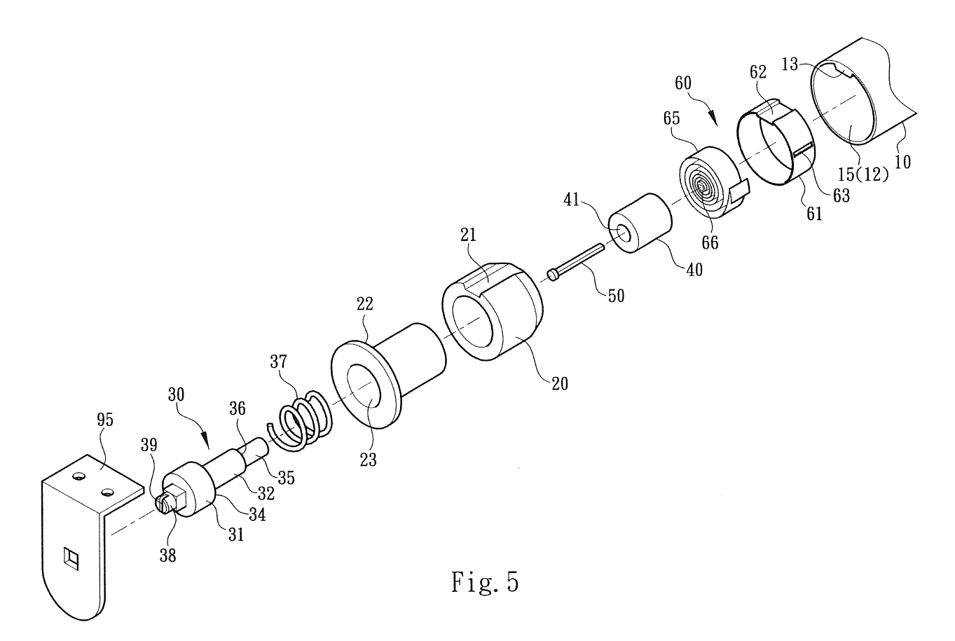

Please now refer to FIGS. 5 and 6. The transmission shaft 50 disposed in the second section 12 of the tubular body 10 is pivotally connected with a band-type spring module 60. The band-type spring module 60 includes a housing 61 and a belt spring 65 disposed in the housing 61. The housing 61 is formed with a recess 62 and a perforation 63. The drive section 13 of the tubular body 10 is inlaid in the recess 62, whereby the housing 61 is rotatable along with the tubular body 10. The belt spring 65 is a coiled spring having two ends. One end of the belt spring 65 is affixed to the transmission shaft 50 via a sleeve 66, while the other end of the belt spring 65 is mounted in the perforation 63 of the housing 61.

It should be noted that the elastic force of the belt spring 65 can be adjusted and set to be approximately equal to the total of the weight of the shade 90 and the elastic force of the elastic member 37. Accordingly, when a user pulls the shade 90 to make the tubular body 10 drive the rotational section 52 and the connector 20 of the first section 11 and the housing 61 and the connector 20 of the second section 12 to rotate, the belt spring 65 and the elastic member 37 will store energy. When the pulling force of the user disappears, the shade 90 stops moving and is located. In the case that the user pushes the shade 90 back to its home position, the belt spring 65 and the elastic member 37 will release the previously stored energy to save the operational strength.

In comparison with the conventional device, the spring-assisted cordless roller shade without clutch system of the present invention has the following advantages:
1. The tubular body 10, the connector 20, the central shaft 30, the fixing member 40, the band-type spring module 60 and the relevant components (such as the connector 20 assembled with the base seat 22, the chamber 23 and the extension wall 24 of the base seat 22, the central shaft 30 mounted in the chamber 23, the head section 31, shaft section 32, the buffering room 33 and the shoulder section 34 of the central shaft 30, the elastic member 37 fitted around the shaft section 32, the free end 35 assembled with the fixing member 40, the transmission shaft 50 pivotally connected with the rotational section 52 or the band-type spring module 60) are redesigned and different from the conventional device in use and operation form.
2. The tubular body 10, the connector 20, the central shaft 30, the fixing member 40, the band-type spring module 60 and the relevant components are such designed as to be different from the conventional device in which a bead chain system is used as a transmission means. The design of the present invention not only enhances the security in operation, but also overcomes the problem of the conventional device that the installation is troublesome and the operation is laborious.

In conclusion, spring-assisted cordless roller shade without clutch system of the present invention is different from and advantageous over the conventional device.

The above embodiments are only used to illustrate the present invention, not intended to limit the scope thereof. Many modifications of the above embodiments can be made without departing from the spirit of the present invention.

What is claimed is:

1. A spring-assisted cordless roller shade without clutch system comprising:
a tubular body defining an internal space, at least one connector being mounted in the internal space and rotatable along with the tubular body;
a central shaft assembled with the connector, the central shaft having a free end;
a fixing member pivotally connected with the free end;
a transmission shaft disposed in the fixing member; and
a band-type spring module assembled with the transmission shaft.

2. The spring-assisted cordless roller shade without clutch system as claimed in claim 1, wherein the internal space of the tubular body has a first section and a second section, in each of the first and second sections being mounted the connector, the central shaft, the fixing member and the transmission shaft, a rotational section being mounted on the transmission shaft of the first section, the rotational section being rotatable along with the tubular body, the transmission shaft of the second section being assembled with the band-type spring module.

3. The spring-assisted cordless roller shade without clutch system as claimed in claim 1, wherein a base seat is assembled with the connector, the base seat being a tubular body defining a chamber and having an extension wall, the central shaft being mounted in the chamber, the central shaft including a head section and a shaft section connected with the head section, the central shaft having a buffering room, the head section having a width larger than a width of the shaft section, whereby a shoulder section is formed between the head section and the shaft section, the free end being formed on the shaft section to extend out of the base seat, an elastic member being disposed between the chamber of the base seat and the shaft section of the central shaft, permitting the central shaft to axially move within the chamber.

4. The spring-assisted cordless roller shade without clutch system as claimed in claim 2, wherein a base seat is assembled with the connector, the base seat being a tubular body defining a chamber and having an extension wall, the central shaft being mounted in the chamber, the central shaft including a head section and a shaft section connected with the head section, the central shaft having a buffering room, the head section having a width larger than a width of the shaft section, whereby a shoulder section is formed between the head section and the shaft section, the free end being formed on the shaft section to extend out of the base seat, an elastic member being disposed between the chamber of the base seat and the shaft section of the central shaft, permitting the central shaft to axially move within the chamber.

5. The spring-assisted cordless roller shade without clutch system as claimed in claim 4, wherein the elastic member is a compression spring fitted around the shaft section, one end of the elastic member abutting against the shoulder section, while the other end of the elastic member abutting against the extension wall of the base seat, the fixing member being formed with a through hole in which the transmission shaft is pivotally fitted, the transmission shaft of the first section extending out of the fixing member, an elastic element being fitted around the transmission shaft, the rotational section being pivotally fitted on the transmission shaft.

6. The spring-assisted cordless roller shade without clutch system as claimed in claim 5, wherein the elastic element is a torsion spring having two ends respectively affixed to the fixing member and the rotational section, the rotational section having the form of a rotational disc, the rotational section being formed with a shaft hole in which the transmission shaft of the first section is pivotally fitted, the rotational section being formed with a notch in which a drive section of the tubular body is inlaid.

7. The spring-assisted cordless roller shade without clutch system as claimed in claim 1, wherein the band-type spring module includes a housing and a belt spring disposed in the housing, the housing being formed with a recess and a perforation, a drive section of the tubular body being inlaid in the recess, whereby the housing is rotatable along with the tubular body, the belt spring being a coiled spring having two ends, one end of the belt spring being affixed to the transmission shaft via a sleeve, while the other end of the belt spring being mounted in the perforation of the housing.

8. The spring-assisted cordless roller shade without clutch system as claimed in claim 2, wherein the band-type spring module includes a housing and a belt spring disposed in the housing, the housing being formed with a recess and a perforation, a drive section of the tubular body being inlaid in the recess, whereby the housing is rotatable along with the tubular body, the belt spring being a coiled spring having two ends, one end of the belt spring being affixed to the transmission shaft via a sleeve, while the other end of the belt spring being mounted in the perforation of the housing.

9. The spring-assisted cordless roller shade without clutch system as claimed in claim 3, wherein the band-type spring module includes a housing and a belt spring disposed in the housing, the housing being formed with a recess and a perforation, a drive section of the tubular body being inlaid in the recess, whereby the housing is rotatable along with the tubular body, the belt spring being a coiled spring having two ends, one end of the belt spring being affixed to the transmission shaft via a sleeve, while the other end of the belt spring being mounted in the perforation of the housing.

10. The spring-assisted cordless roller shade without clutch system as claimed in claim 4, wherein the band-type spring module includes a housing and a belt spring disposed in the housing, the housing being formed with a recess and a perforation, a drive section of the tubular body being inlaid in the recess, whereby the housing is rotatable along with the tubular body, the belt spring being a coiled spring having two ends, one end of the belt spring being affixed to the transmission shaft via a sleeve, while the other end of the belt spring being mounted in the perforation of the housing.

11. The spring-assisted cordless roller shade without clutch system as claimed in claim 5, wherein the band-type spring module includes a housing and a belt spring disposed in the housing, the housing being formed with a recess and a perforation, a drive section of the tubular body being inlaid in the recess, whereby the housing is rotatable along with the tubular body, the belt spring being a coiled spring having two ends, one end of the belt spring being affixed to the transmission shaft via a sleeve, while the other end of the belt spring being mounted in the perforation of the housing.

12. The spring-assisted cordless roller shade without clutch system as claimed in claim 6, wherein the band-type spring module includes a housing and a belt spring disposed in the housing, the housing being formed with a recess and a perforation, a drive section of the tubular body being inlaid in the recess, whereby the housing is rotatable along with the tubular body, the belt spring being a coiled spring having two ends, one end of the belt spring being affixed to the transmission shaft via a sleeve, while the other end of the belt spring being mounted in the perforation of the housing.

13. The spring-assisted cordless roller shade without clutch system as claimed in claim 1, wherein a boss section is formed on the head section of the central shaft, a split being formed on the boss section, a fixing plate being assembled with the boss section, whereby the tubular body can be mounted on a base face.

14. The spring-assisted cordless roller shade without clutch system as claimed in claim 2, wherein a boss section is formed on the head section of the central shaft, a split being formed on the boss section, a fixing plate being assembled with the boss section, whereby the tubular body can be mounted on a base face.

15. The spring-assisted cordless roller shade without clutch system as claimed in claim 3, wherein a boss section is formed on the head section of the central shaft, a split being formed on the boss section, a fixing plate being assembled with the boss section, whereby the tubular body can be mounted on a base face.

16. The spring-assisted cordless roller shade without clutch system as claimed in claim 4, wherein a boss section is formed on the head section of the central shaft, a split being formed on the boss section, a fixing plate being assembled with the boss section, whereby the tubular body can be mounted on a base face.

17. The spring-assisted cordless roller shade without clutch system as claimed in claim 5, wherein a boss section is formed on the head section of the central shaft, a split being formed on the boss section, a fixing plate being assembled with the boss sect ion, whereby the tubular body can be mounted on a base face.

18. The spring-assisted cordless roller shade without clutch system as claimed in claim 6, wherein a boss section is formed on the head section of the central shaft, a split being formed on the boss section, a fixing plate being assembled with the boss section, whereby the tubular body can be mounted on a base face.

19. The spring-assisted cordless roller shade without clutch system as claimed in claim 7, wherein a boss section is formed on the head section of the central shaft, a split being formed on the boss section, a fixing plate being assembled with the boss section, whereby the tubular body can be mounted on a base face.

20. The spring-assisted cordless roller shade without clutch system as claimed in claim 8, wherein a boss section is formed on the head section of the central shaft, a split being formed on the boss section, a fixing plate being assembled with the boss section, whereby the tubular body can be mounted on a base face.

21. The spring-assisted cordless roller shade without clutch system as claimed in claim 1, wherein the connector is a cylindrical body formed with a channel, the tubular body having a drive section inlaid in the channel of the connector.

22. The spring-assisted cordless roller shade without clutch system as claimed in claim 2, wherein the connector is a cylindrical body formed with a channel, the tubular body having a drive section inlaid in the channel of the connector.

23. The spring-assisted cordless roller shade without clutch system as claimed in claim 3, wherein the connector is a cylindrical body formed with a channel, the tubular body having a drive section inlaid in the channel of the connector.

24. The spring-assisted cordless roller shade without clutch system as claimed in claim 4, wherein the connector is a cylindrical body formed with a channel, the tubular body having a drive section inlaid in the channel of the connector.

25. The spring-assisted cordless roller shade without clutch system as claimed in claim 5, wherein the connector is a cylindrical body formed with a channel, the tubular body having a drive section inlaid in the channel of the connector.

26. The spring-assisted cordless roller shade without clutch system as claimed in claim 6, wherein the connector is a cylindrical body formed with a channel, the tubular body having a drive section inlaid in the channel of the connector.

27. The spring-assisted cordless roller shade without clutch system as claimed in claim 7, wherein the connector is a cylindrical body formed with a channel, the tubular body having a drive section inlaid in the channel of the connector.

28. The spring-assisted cordless roller shade without clutch system as claimed in claim 13, wherein the connector is a cylindrical body formed with a channel, the tubular body having a drive section inlaid in the channel of the connector.

29. The spring-assisted cordless roller shade without clutch system as claimed in claim 19, wherein the connector is a cylindrical body formed with a channel, the tubular body having a drive section inlaid in the channel of the connector.

30. The spring-assisted cordless roller shade without clutch system as claimed in claim 20, wherein the connector is a cylindrical body formed with a channel, the tubular body having a drive section inlaid in the channel of the connector.

31. The spring-assisted cordless roller shade without clutch system as claimed in claim 7, wherein the elastic force of the belt spring is at least equal to the total of the weight of a shade and the elastic force of the elastic member, the shade being wound on the tubular body.

32. The spring-assisted cordless roller shade without clutch system as claimed in claim 13, wherein the elastic force of the belt is at least equal to the total of the weight of a shade and the elastic force of the elastic member, the shade being wound on the tubular body.

33. The spring-assisted cordless roller shade without clutch system as claimed in claim 19, wherein the elastic force of the belt spring is at least equal to the total of the weight of a shade and the elastic force of the elastic member, the shade being wound on the tubular body.

34. The spring-assisted cordless roller shade without clutch system as claimed in claim 20, wherein the elastic force of the belt spring is at least equal to the total of the weight of a shade and the elastic force of the elastic member, the shade being wound on the tubular body.

35. The spring-assisted cordless roller shade without clutch system as claimed in claim 3, wherein a subsidiary shoulder section is formed on a surface of the shaft section in a position where the shaft section protrudes out of the base seat.

36. The spring-assisted cordless roller shade without clutch system as claimed in claim 4, wherein a subsidiary shoulder section is formed on a surface of the shaft section in a position where the shaft section protrudes out of the base seat.

37. The spring-assisted cordless roller shade without clutch system as claimed in claim 5, wherein a subsidiary shoulder section is formed on a surface of the shaft section in a position where the shaft section protrudes out of the base seat.

38. The spring-assisted cordless roller shade without clutch system as claimed in claim 6, wherein a subsidiary shoulder section is formed on a surface of the shaft section in a position where the shaft section protrudes out of the base seat.
